(19) United States
(12) Patent Application Publication
(10) Pub. No.: US 2025/0003428 A1
(43) Pub. Date: Jan. 2, 2025

(54) Piston Accumulator

(71) Applicant: Hydac Technology GmbH, Sulzbach / Saar (DE)

(72) Inventors: Norbert Weber, Saarsbrücken (DE); Yannik Zimmer, St. Wendel/Saal (DE); Sven Mann, Püttlingen (DE)

(73) Assignee: Hydac Technology GmbH, Sulzbach / Saar (DE)

(21) Appl. No.: 18/712,360

(22) PCT Filed: Dec. 20, 2022
(86) PCT No.: PCT/EP2022/086999

§ 371 Date: May 22, 2024

(30) Foreign Application Priority Data
Jan. 12, 2022 (DE) 10 2022 000 098.9

(51) Int. Cl. F15B 1/24

(52) U.S. Cl. CPC F15B 1/24

(57) ABSTRACT

The disclosure relates to a piston accumulator, having an accumulator housing, in which a separating piston is longitudinally movably guided, that separates two fluid chambers from one another and which separating piston has a damping piston with a check valve, which damping piston can be introduced into a fluid connection in the accumulator housing to form a throttle gap. The throttle gap is a cylindrical annular chamber, formed from the adjacent wall parts of the accumulator housing and the damping piston. The check valve has a valve ball which is acted upon by an energy accumulator and which, in a closed position, blocks a fluid path between the fluid connection and a piston fluid chamber between the separating piston and the accumulator housing and, in its open position, opens said fluid path.

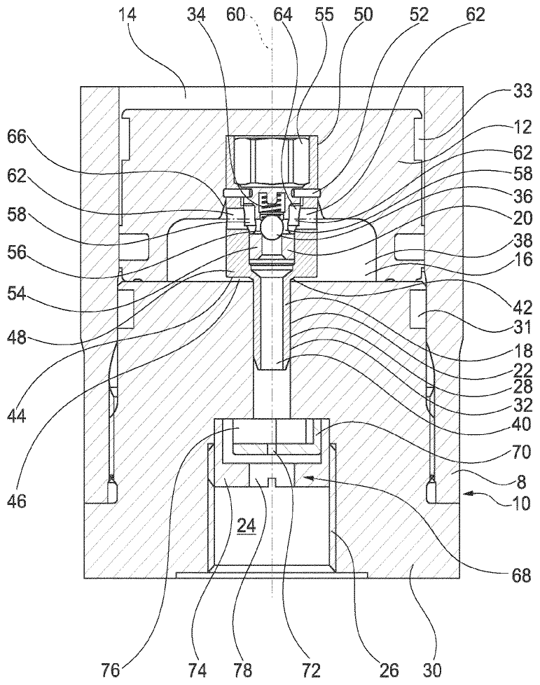

### CROSS-REFERENCE TO RELATED APPLICATIONS

This application claims priority to German Patent Application No. DE 10 2022 000 098.9, filed on Jan. 12, 2022 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a piston accumulator having an accumulator housing, in which a separating piston is guided so as to be longitudinally movable, which separating piston separates two fluid chambers from each other, in particular separates a fluid chamber having a working gas from a further fluid chamber having a liquid, such as hydraulic oil, and which separating piston has a damping piston with a check valve, which damping piston can be introduced into a fluid port in the accumulator housing to form a throttle gap.

EP 0 286 777 A2 discloses a generic piston-cylinder unit with piston end position damping which has a damping piston protruding from the end face of the piston, which damping piston can be retracted into a damping chamber provided at the facing cylinder end, forming a damping gap which tapers conically towards the fluid port, and a flow path is provided for initiating a return stroke movement of the piston, which leads from the fluid port for pressure oil, bypassing the damping gap, to the pressure chamber adjacent to the main piston surface of the piston in the accumulator housing and contains a check valve. This flow path, which can be controlled by the check valve, extends within the piston between an inlet opening at the front end of the damping piston, which is configured as a hollow sleeve, and an aperture leading from the interior of this sleeve to the outside in the form of a transverse channel. The check valve used in this respect has a solid valve plate which can be controlled by an energy accumulator in the form of a compression spring that controls a large opening cross-section in the damping piston, which results in leaks in the closed position and is accompanied by turbulence in the flow pattern when the valve is open. Furthermore, rapid opening and closing processes are excluded due to the inertia behaviour of the valve plate.

### SUMMARY

A need exists to provide a piston accumulator with improved end position damping for the separating piston in addition to improved response behaviour when fluid flows into or out of the hydraulic accumulator.

The need is addressed by the subject matter of the independent claim(s). Embodiments of the invention are described in the dependent claims, the following description, and the drawings.

### BRIEF DESCRIPTION OF THE DRAWINGS

The FIG. shows the lower part of an otherwise conventional piston accumulator in the manner of a longitudinal section.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, the throttle gap is a cylindrical annular space, formed from the adjacent wall parts of the accumulator housing and the damping piston, and the check valve has a valve ball which is acted upon by an energy accumulator which, in its closed position, blocks a fluid path between the fluid port and a piston fluid chamber between the separating piston and the accumulator housing and, in its open position, opens said fluid path. This means that a constant throttle gap width is achieved over the entire engagement length of the damping piston in the fluid port which results in improved end position damping. Since there is no need to take account of any continuously changing gap geometry with conical sections, the engagement length for the damping piston in the fluid port can be selected to be extremely long within predefinable limits due to the geometry to be maintained for the hydraulic accumulator, so that significantly improved end position damping of the piston is achieved in conjunction with the constant gap dimension over the entire engagement length. Furthermore, the valve ball of the check valve allows the implementation of an improved valve seat geometry with improved leak tightness in the closed position and reduced turbulence during flow in the open position. Due to the low mass inertia of the valve or closing ball, which can be correspondingly small in size, the fluid flows occurring in each case during charging and discharging of the hydraulic accumulator can be reliably controlled in rapid succession. This thus has no equivalent in prior art.

In some embodiments, it is provided that the damping piston is formed from a hollow cylinder which, at least in one of its damping positions, establishes a fluid path between the fluid port and the check valve with its hollow cylindrical passage. In this case, the diameter of the hollow cylinder in the damping piston corresponds substantially to the diameter of the valve closing ball so that when charging the accumulator with fluid, such as hydraulic oil, there is a central flow onto the valve ball and it can therefore lift off its valve seat in the associated valve housing without obstruction.

In some embodiments, it is provided that the damping piston, viewed in the direction of the piston fluid chamber, merges, forming a shoulder, into an extension which has an annular surface which, when the separating piston bears against part of the accumulator housing, such as a housing cover, forms an annular gap, the gap dimension of which is greater than the gap dimension of the throttle gap. In this way, there is further damping of the separating piston movement via the annular gap until the separating piston comes to rest completely on the adjacent upper side of the housing cover in its lower travel position when the accumulator is discharged, so that both the throttle gap and the annular gap together provide the damping for the aforementioned movement of the separating piston.

In some embodiments, it is provided that the annular surface is part of an insert body which accommodates the check valve and which is fixed in a receptacle of the separating piston, for example by means of a circlip between the insert body and the separating piston. As the check valve is an integral part of the insert body, the damping device as a whole can be connected to the separating piston from a central point, in particular from the underside of the separating piston, making installation extremely easy and involving few work steps. In this respect, the piston accumulator solution can also be produced cost-effectively.

In some embodiments, it is provided that the check valve is designed as a valve cartridge with its valve housing screwed into the insert body and that the valve ball, permanently impinged on by the energy accumulator in the form of a compression spring, is guided in the valve housing. A valve cartridge of this type is standard on the market and can be adapted to different sizes of hydraulic accumulator, particularly in terms of the connection geometry, which is conducive to functionally reliable and cost-effective construction of the overall end position damping.

The valve housing for example has at least one transverse channel which leads from the valve ball of the check valve in a controllable manner towards an associated transverse channel in the insert body. In this case, the valve housing for example has a groove on the outer circumference, for example in the form of an annular valve chamber, into which the respective transverse channel of the valve housing opens from one side and the respectively assigned transverse channel in the insert body opens from the other, opposing side. In this way, overall flow guidance is achieved through the valve housing together with the insert body, an effectively 90° deflection of the vertically incoming fluid flow during charging of the accumulator deflecting this fluid flow into a transverse guide towards the piston fluid chamber, which is particularly favourable in terms of energy and results directly in timely actuation of the separating piston during the charging process.

In some embodiments, it is provided that the separating piston defines a hollow chamber-like recess on its side directed towards the fluid port, which recess opens out towards the circlip into a slope and that the bore axis of the respective transverse channel in the insert body is aligned with a wall of the separating piston, which at least partially defines the recess in the separating piston and at which the slope opens into the recess. The for example circumferential slope mentioned can be used to securely position the circlip for fixing the insert body in the separating piston and the slope can also serve as an inflow aid to directly convert a transverse application of force by the fluid flow into a stroke movement for the separating piston as part of an accumulator charging process.

As already explained, it is in some embodiments provided here that the axial length of the damping piston is greater than the comparable height of the piston fluid chamber in the separating piston, which is at least partially penetrated by the insert body. Practical tests have shown that this length/height configuration results in particularly good damping properties during the discharging process of the accumulator and that, in the reverse direction, the separating piston moves towards the fluid chamber having the working gas without obstruction when the accumulator is charged and is precharged in the process.

The disclosure further relates to a method for operating a piston accumulator comprising the following method steps:
Throttling of the volumetric flow during discharging of the piston accumulator by forming a hollow cylindrical throttle gap between the damping piston and parts of the accumulator housing,
Bypassing the throttle gap during charging of the piston accumulator by opening a check valve which is integrated in the separating piston and has a valve ball impinged on by an energy accumulator due to the resulting pressure difference in the throttle gap, and as a result
Admitting fluid pressure to the entire free piston cross-section for directly moving the separating piston towards the other fluid chamber having the working gas.

The piston accumulator is explained in greater detail below with reference to an embodiment according to the drawing. Specific references to components, process steps, and other elements are not intended to be limiting.

The FIG. shows the lower part of a piston accumulator having a hollow cylindrical wall part 8 of an accumulator housing denoted as a whole by 10, in which a separating piston 12 is guided so as to be longitudinally movable, which separating piston separates two fluid chambers 14, 16 from each other, in particular a fluid chamber 14 having a working gas, such as nitrogen, from a further fluid chamber 16 having an operating fluid, such as hydraulic oil. In addition, the separating piston 12 has a damping piston 18 with a check valve 20 on its free end-face end. The damping piston 18 can move into a fluid port 24 in the accumulator housing 10, forming a throttle gap 22, the FIG. showing the maximum lowest position for the separating piston 12 in the accumulator housing 10, with maximum throttling of the fluid flow from the side of the fluid chamber 16 towards the fluid port 24. The aforementioned position of the separating piston 12 shown in the FIG. corresponds to the maximum discharging situation for the hydraulic accumulator as a whole. Via an internal thread 26 in the fluid port 24, the piston accumulator can be connected in the usual way to a hydraulic circuit of conventional design, which is not shown, by means of piping which is not shown.

As further emerges from the FIG., the throttle gap 22 is a cylindrical annular space or hollow cylinder filled with fluid, formed from the adjacent wall parts 28 of the accumulator housing 10 in the form of a housing cover 30 and the opposing, adjacently arranged wall parts 32 of the damping piston 18. The housing cover 30, as part of the accumulator housing 10, is screwed into the bottom of the hollow cylindrical wall part 8 thereof and sealed with respect to the rest of the accumulator housing 10 via a ring seal in an annular groove 31, which is not shown is greater detail. The separating piston 12 has two annular grooves 33 on the outer circumference for receiving sealing rings and guide bands, not shown in greater detail, of which only the upper one is denoted by 33. The check valve 20 has a valve ball 36 which is permanently acted upon by an energy accumulator in the form of a compression spring 34 which, in its closed position shown in the FIG., blocks a fluid path between the fluid port 24 and a piston fluid chamber 38 between the separating piston 12 and the accumulator housing 10 or the housing cover 30 and, in an open position, opens this fluid path against the action of the compression spring 34. In the present case, the piston fluid chamber 38 is formed from a chamber-like recess on the underside of the separating piston 12, which recess is surrounded on the outer circumference at the level of the sealing ring system in the annular groove 33 by wall parts of the separating piston 12.

As can further be seen from the FIG., the damping piston 18 is formed from a hollow cylinder which, at least in one of its damping positions, in a fully damped position in the FIG., establishes the fluid path between the fluid port 24 and the check valve 20 with its valve ball 36 by means of its hollow cylindrical passage 40. The damping piston 18 reduced in diameter, viewed in the direction of the piston fluid chamber 38, merges, forming a shoulder 42, into an extension which by comparison has an enlarged diameter and an annular surface 44 which, when the separating piston 12 bears against parts of the accumulator housing 10 in the form of the housing cover 30, forms an annular gap 46, according to the diagram shown in the FIG., the gap dimension of which is for example selected to be larger than the free gap dimension of the throttle gap 22.

The annular surface 44 is part of an insert body 48 which accommodates the check valve 20 as a whole and which is held in a hollow cylindrical receptacle 50 of the separating piston 12 by means of a circlip 52 between the insert body 48 and the separating piston 12. In this respect, the check valve 20 is designed as a valve cartridge, which is screwed with its valve housing 54 into the insert body 48 using a hexagon socket screw 55 and, as shown in the diagram according to the FIG., the valve ball 36 is held in its closed position under the action of the compression spring 34 on a valve seat 56 in the valve housing 54 in a leak-proof manner. The aforementioned valve housing 54 has a transverse channel 58 diametrically opposite the longitudinal axis 60 of the hydraulic accumulator, which transverse channel connects directly to the valve ball 36 and can be actuated thereby. Instead of a pair of transverse channels 58, a different number of transverse channels 58 can also be provided, in particular only a single transverse channel 58. The respective transverse channel 58 opens out in the valve housing 54 towards an assignable further transverse channel 62 in the insert body 48. Between the pairs of transverse channels 58 and 62 assigned to each other, the valve housing 54 has a groove 64 on the outer circumference, for example in the form of an annular valve chamber, into which the respective transverse channel 58 of the valve housing 54 opens from one side and the respectively assigned transverse channel 62 in the insert body 58 opens from the other, opposing side. The separating piston 12 defines a hollow chamber-like recess on its side directed towards the fluid port 24 as part of the piston fluid chamber 38, which recess opens out towards the circlip 52 into a slope 66 in the separating piston 12, which tapers conically upwards in the direction of the longitudinal axis 60. At the same time, the bore axis of the respective transverse channel 62 in the insert body 48 is aligned with the upper wall boundary of the recess in the separating piston 12, the slope 66, which is guided circumferentially in the separating piston 12, opening into the aforementioned upper boundary wall. It is beneficial for the piston accumulator solution that the axial length of the damping piston 18, insofar as it is in engagement with parts of the fluid port 24, is in any case greater than the comparable height of the piston fluid chamber 38, formed by the recess in the separating piston 12, which in this respect is at least partially penetrated by the insert body 46.

The piston accumulator shown in the FIG. can then be operated with the equipment according to the teachings herein as follows:
Throttling of the volumetric flow during discharging of the piston accumulator by forming the hollow cylindrical throttle gap 22 between the damping piston 18 and parts of the accumulator housing 10, the associated downwards movement of the separating piston 12 displacing fluid from the fluid chamber 16 via the throttle gap 22 towards the fluid port 24 which is kept depressurised. Further throttling takes place through the annular gap 46 between the insert body 48 and the adjacent top side of the wall of the housing cover 30;
Bypassing the aforementioned throttle gap 22, 46 during charging of the piston accumulator by opening a check valve 20 which is integrated in the separating piston 12 and has a valve ball 36 impinged on by the compression spring 34 due to the resulting pressure difference, in particular in the throttle gap 22. The fluid pressure prevailing in the fluid port 24 opens the said check valve 20 and fluid flows via the hollow cylindrical passage 40 and via the interior of the valve housing 54 towards the transverse channels 58 and 62 which are connected to the groove 64 of the valve housing 54 in a fluid-conducting manner. In this way, pressurised fluid enters the piston fluid chamber 38 via the fluid port 24 and the separating piston 12 lifts upwards, viewed in the direction of the FIG. With further displacement movement against the action of the working gas in the fluid chamber 14, the fluid volume on the liquid side having the fluid chamber 16 increases. This results as follows in
Admitting fluid pressure to the entire free piston cross-section for directly moving of the separating piston 12 towards the other fluid chamber 14 having the working gas. As soon as the damping piston 18 completely releases the fluid passage 24 towards the fluid chamber 14 due to the displacement movement of the separating piston 12, fluid flows from the hydraulic circuit towards the fluid chamber 16 to an increased extent. In the corresponding operating position, the hydraulic accumulator is then available again for a discharging process as described.

In the region of the internal thread 26 of the fluid port 24, there is a damping valve denoted as a whole by 68 with a longitudinally displaceable valve plate 70 in which a throttle bore 72 is introduced coaxial with the longitudinal axis 60 of the hydraulic accumulator. The aforementioned valve plate 70 is accommodated in a valve housing 74, for example configured as a tripod, which is screwed flush into the fluid port 24 along the internal thread 26. Since there is a fluid inlet 76 between each of the legs of the valve housing 74, in the position shown for charging the accumulator, fluid can flow in relatively undisturbed from the hydraulic working circuit via the fluid port 24 at a predefinable pressure towards the fluid chamber 16 via a bottom-side inlet 78 in the valve housing 74 to charge the accumulator when the check valve 20 is open. Conversely, i.e. when discharging the accumulator, the valve plate 70 moves from its upper travel position shown in the FIG. to a lower closed position, in which the valve plate 70 rests on the inside of the valve housing 74 and a fluid passage is then only provided via the throttle bore 72 in the valve plate 70, so that throttling of the fluid flow is also implemented in this respect by the damping valve 68 in addition to the throttling measures 22, 46 already described. Further details on the function of aforementioned damping valves also emerge by way of example from DE 103 37 744 B3.

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-10. (canceled)

11. A piston accumulator having an accumulator housing, in which a separating piston is guided so as to be longitudinally movable, which separating piston separates two fluid chambers from each other, and which separating piston has a damping piston with a check valve, which damping piston can be introduced into a fluid port in the accumulator housing to form a throttle gap, wherein the throttle gap is a cylindrical annular space formed from the adjacent wall parts of the accumulator housing and the damping piston and wherein the check valve has a valve ball which is acted upon by an energy accumulator and which, in its closed position, blocks a fluid path between the fluid port and a piston fluid chamber between the separating piston and the accumulator housing and, in its open position, opens said fluid path.

12. The piston accumulator of claim 11, wherein the damping piston is formed from a hollow cylinder which, at least in one of its damping positions, establishes a fluid path between the fluid port and the check valve with its hollow cylindrical passage.

13. The piston accumulator of claim 11, wherein the damping piston, viewed in the direction of the piston fluid chamber, merges, forming a shoulder, into an extension with an annular surface which, when the separating piston bears against parts of the accumulator housing, forms an annular gap, the gap dimension of which is greater than the gap dimension of the throttle gap.

14. The piston accumulator of claim 11, wherein the annular surface is part of an insert body which accommodates the check valve and which is fixed in a receptacle of the separating piston.

15. The piston accumulator of claim 11, wherein the check valve is configured as a valve cartridge with its valve housing screwed into the insert body and wherein the valve ball, permanently impinged on by the energy accumulator in the form of a compression spring, is guided in the valve housing.

16. The piston accumulator of claim 11, wherein the valve housing has at least one transverse channel which leads from the valve ball of the check valve in a controllable manner towards an associated transverse channel in the insert body.

17. The piston accumulator of claim 11, wherein the valve housing has a groove on the outer circumference, into which the respective transverse channel of the valve housing opens from one side and the respectively assigned transverse channel in the insert body opens from the other, opposing side.

18. The piston accumulator of claim 11, wherein the separating piston defines a hollow chamber-like recess on its side directed towards the fluid port as part of the piston fluid chamber, which recess opens out towards the circlip into a slope in the separating piston, and wherein the bore axis of the respective transverse channel in the insert body is aligned with a wall of the separating piston, which wall at least partially defines the recess in the separating piston and into which the slope opens.

19. The piston accumulator of claim 11, wherein the axial length of the damping piston is greater than the comparable height of the piston fluid chamber in the separating piston, which is at least partially penetrated by the insert body.

20. Method for operating a piston accumulator, comprising:
throttling of the volumetric flow during discharging of the piston accumulator by forming a hollow cylindrical throttle gap between the damping piston and parts of the accumulator housing;
bypassing the throttle gap during charging of the piston accumulator by opening a check valve which is integrated in the separating piston and has a valve ball impinged on by an energy accumulator due to the resulting pressure difference in the throttle gap; and as a result
admitting fluid pressure to the entire free piston cross-section for directly moving the separating piston towards the other fluid chamber having the working gas.

21. The piston accumulator of claim 11, wherein the separating piston separates a first fluid chamber having a working gas from a further fluid chamber having a liquid.

22. The piston accumulator of claim 21, wherein the liquid is hydraulic oil.

23. The piston accumulator of claim 12, wherein the damping piston, viewed in the direction of the piston fluid chamber, merges, forming a shoulder, into an extension with an annular surface which, when the separating piston bears against parts of the accumulator housing, forms an annular gap, the gap dimension of which is greater than the gap dimension of the throttle gap.

24. The piston accumulator of claim 11, wherein the annular surface is part of an insert body which accommodates the check valve, and which is fixed in a receptacle of the separating piston by means of a circlip between the insert body and the separating piston.

25. The piston accumulator of claim 12, wherein the annular surface is part of an insert body which accommodates the check valve, and which is fixed in a receptacle of the separating piston.

26. The piston accumulator of claim 13, wherein the annular surface is part of an insert body which accommodates the check valve, and which is fixed in a receptacle of the separating piston.

27. The piston accumulator of claim 12, wherein the check valve is configured as a valve cartridge with its valve housing screwed into the insert body and wherein the valve ball, permanently impinged on by the energy accumulator in the form of a compression spring, is guided in the valve housing.

28. The piston accumulator of claim 13, wherein the check valve is configured as a valve cartridge with its valve housing screwed into the insert body and wherein the valve ball, permanently impinged on by the energy accumulator in the form of a compression spring, is guided in the valve housing.

29. The piston accumulator of claim 14, wherein the check valve is configured as a valve cartridge with its valve housing screwed into the insert body and wherein the valve ball, permanently impinged on by the energy accumulator in the form of a compression spring, is guided in the valve housing.

30. The piston accumulator of claim 11, wherein the valve housing has a groove on the outer circumference in the form of an annular valve chamber, into which the respective transverse channel of the valve housing opens from one side and the respectively assigned transverse channel in the insert body opens from the other, opposing side.
